(19) United States
(12) Patent Application Publication
(10) Pub. No.: US 2005/0073655 A1
(43) Pub. Date: Apr. 7, 2005

(54) Four color channel kernel

(76) Inventor: Arthur Berman, San Jose, CA (US)

Correspondence Address: John W. Carpenter;REED SMITH LLP, Suite 2000, Two Embarcadero Center, San Francisco, CA, 94111, US

(21) Appl. No.: 10/923,491

(22) Filed: Aug. 20, 2004

Related U.S. Application Data
(60) Provisional application No. 60/508,757, filed on Oct. 3, 2003.
(60) Provisional application No. 60/535,709, filed on Jan. 8, 2004.
(60) Provisional application No. 60/587,616, filed on Jul. 12, 2004.

(51) Int. Cl. G03B 21/00

(52) U.S. Cl. 353/33

(57) ABSTRACT

A fourth color channel is added to a kernel. The fourth channel is, for example a yellow light channel that increases the brightness and color gamut of the projected image. Content of an image is added to the fourth channel via a microdisplay that reflects the fourth channel light beam. Any number of algorithms may be implemented to determine the amount of added yellow light into each pixel of an image, based on, for example, the saturation of a pixel, the amount of other colors in the pixel, a selected brightness level (e.g., an overall image brightness selection, a brightness specifically selected for the fourth color channel, etc.), and various factors related to the design and/or performance of the prism assembly, kernel, and/or any of the individual components therein. The fourth color channel (e.g., yellow, cyan, white, or another fourth color) is combined with the first three channels (e.g.: red, green, blue; magenta, cyan, yellow; etc.) at an output of the kernel, increasing a color space and brightness of an image projected by the kernel.

### CROSS-REFERENCE TO RELATED APPLICATIONS

This application is related to and claims all benefit of co-pending U.S. provisional application Ser. No. 60/508,757, filed Oct. 3, 2003, co-pending U.S. provisional application Ser. No. 60/535,709, filed Jan. 8, 2004, and co-pending U.S. provisional application Ser. No. 60/587,616, filed Jul. 12, 2004, the contents of each are incorporated herein by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Discussion of Background

The projection mechanism within a microdisplay based video projector is called a light engine. The optical heart of the light engine is called a kernel that comprises, for example, a prism assembly and microdisplays. In the context of this disclosure, a conventional kernel generally refers to a quad type prism assembly combined with three LCOS microdisplays that modulate red, green, and blue light channels of the prism assembly. However, other kernel configurations are available and are entirely relevant to the discussions presented herein.

The configuration and functionality of one version of the many possible conventional kernels is illustrated in FIG. 1. As shown, the various thin films and materials within the kernel divide the polarized input light into red, green and blue color channels. The saturation of these colors ultimately defines the color gamut of a projected image as illustrated in FIG. 2A.

An image is imposed (modulated) on each of the three light beams by reflection off LCOS microdisplays. The portion of an image displayed on (modulated by) each microdisplay is developed by drive electronics that “decompose” an input, full color video signal into its red, green and blue content which are each provided to a corresponding microdisplay. In this way, the “green” microdisplay (microdisplay that imposes content into the green color channel) “displays” the green content of the video image and so on for the red and blue.

Another technology is the TFT LCD direct view display. In one version of this type of display each pixel is spatially divided into red, green and blue sub pixels. The viewer's eyes spatially integrate the sub pixels into a unified full color image. Yet another technology is the DLP projection display. In one version of this type of display each frame is divided into red, green and blue sub frames. The sub frames are projected in rapid sequence and the viewer's eyes temporally integrate the sub frames into a unified full color image. Regardless of the display type, one design challenge is to project the brightest possible image consistent with a good color gamut.

### SUMMARY OF THE INVENTION

The present inventors have realized the need to address an undesirable inverse relationship between color gamut and image brightness of conventional image projection systems. The present invention includes a fourth color channel in an image projection system and simultaneously increases the color gamut and the brightness of the projected image. The fourth channel is, for example, a yellow light channel or a cyan light channel.

The present inventors have also realized the need to increase brightness in image projection devices and has developed an efficient device and method to provide increased brightness through a “white boost.” “White boost” comprises, for example, the inclusion of a separate “white” sub pixel or sub frame for the purpose of adding lumens in real time to those pixels not displaying a fully saturated color.

The present invention provides a device and method to adapt white boost to a three channel LCoS kernel in order to increase the brightness of the projected image. More specifically, in one embodiment, the present invention incorporates an additional channel into a kernel for the purpose of modulating “white” light (for example, incorporating a fourth “white” light channel into a three channel LCOS kernel).

### BRIEF DESCRIPTION OF THE DRAWINGS

The patent or application file contains at least one drawing executed in color. Copies of this patent or patent application publication with color drawing(s) will be provided by the Office upon request and payment of the necessary fee A more complete appreciation of the invention and many of the attendant advantages thereof will be readily obtained as the same becomes better understood by reference to the following detailed description when considered in connection with the accompanying drawings, wherein:

FIG. 1 is a conventional 3-color channel kernel;

FIG. 2A is a graph illustrating a color gamut of a projected image of a conventional 3-color channel kernel;

FIG. 2B is a graph illustrating a color gamut of a projected image of a 4-color channel kernel according to an embodiment of the present invention;

FIG. 3 is a graph of emission spectra of a mercury short arc lamp;

FIG. 4 is a drawing of a (+cyan) 4 color channel kernel according to an embodiment of the present invention;

FIG. 5 is a graph of an example input light spectrum according to a +cyan embodiment of the present invention;

FIG. 6 is a drawing of a (+yellow) 4 channel kernel according to an embodiment of the present invention;

FIG. 7 is a graph of an example input light spectrum according to the +yellow embodiment of the present invention;

FIG. 8 is a block diagram of a processing device (separator) that separates a full color TV video signal into component signals for driving individual microdisplays according to several embodiments of the present invention;

FIG. 9 is a kernel according to an embodiment of the present invention;

FIG. 10 is an illustration of light manipulated according to the kernel embodiment of FIG. 9;

FIG. 11 is a drawing of a light engine or light management system (LMS) according to an embodiment of the present invention; and

FIG. 12 is a drawing of an arrangement of beam splitters and microdisplays in a 3D kernel configuration.

### DESCRIPTION OF THE PREFERRED EMBODIMENTS

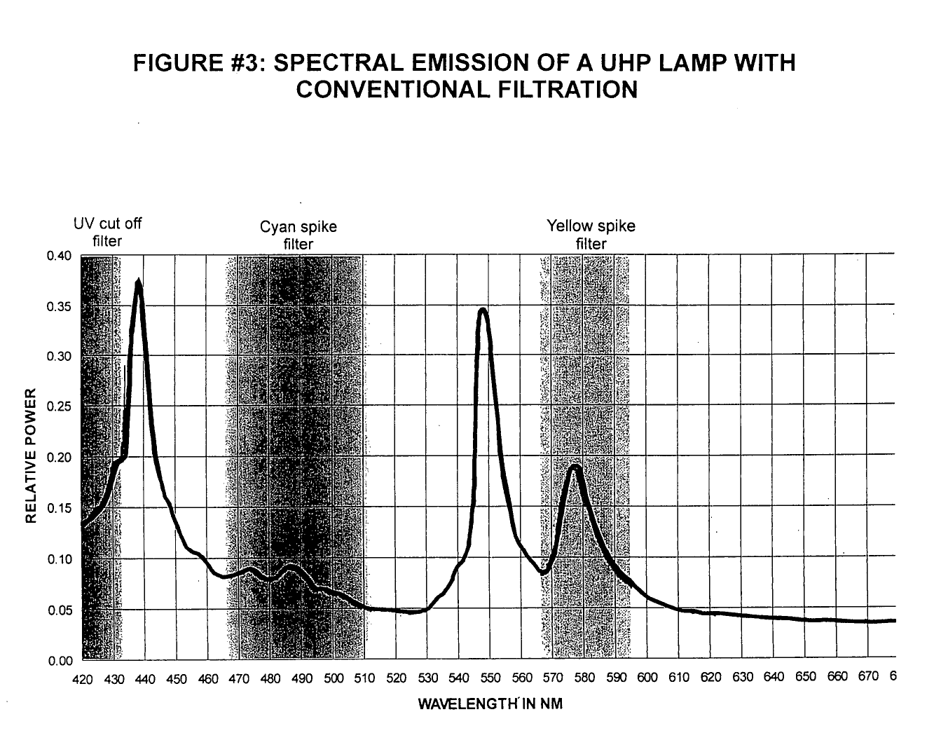

The light source in the illuminator portion of the light engine is typically a short arc mercury lamp. The emission spectrum of such a lamp is illustrated in FIG. 3. In order to produce more saturated colors it is typical to include filters in the illuminator to remove the cyan and yellow portions of the spectrum. A UV filter is also included to remove damaging ultra violet light. The portions of the spectrum removed by these filters are also illustrated in FIG. 3. Points to note are that:
More saturated colors are obtained (i.e. a larger color gamut is obtained) by narrowing the spectrum of light in each channel.
When larger portions of the emission spectra are removed, less light is available for projection. That is, the projected image is less bright.

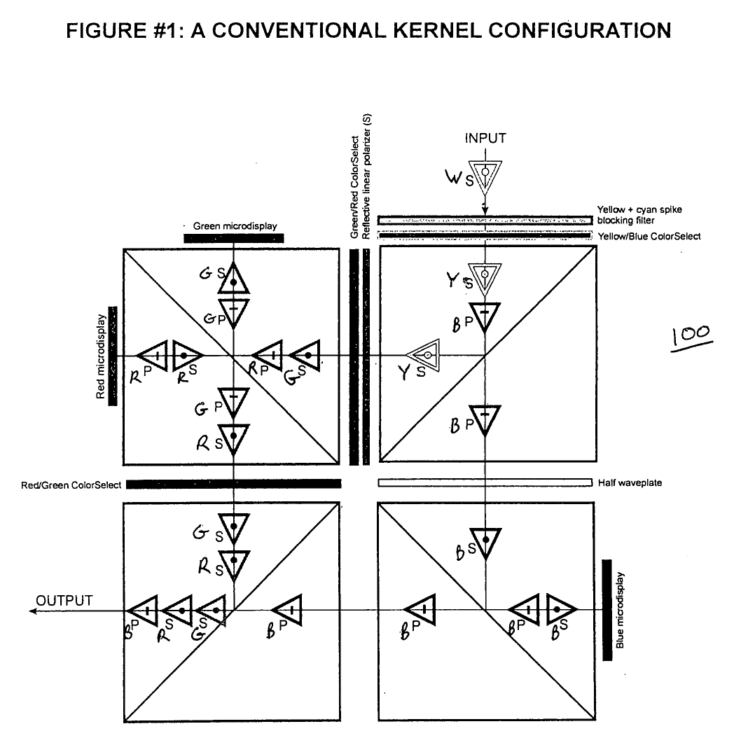

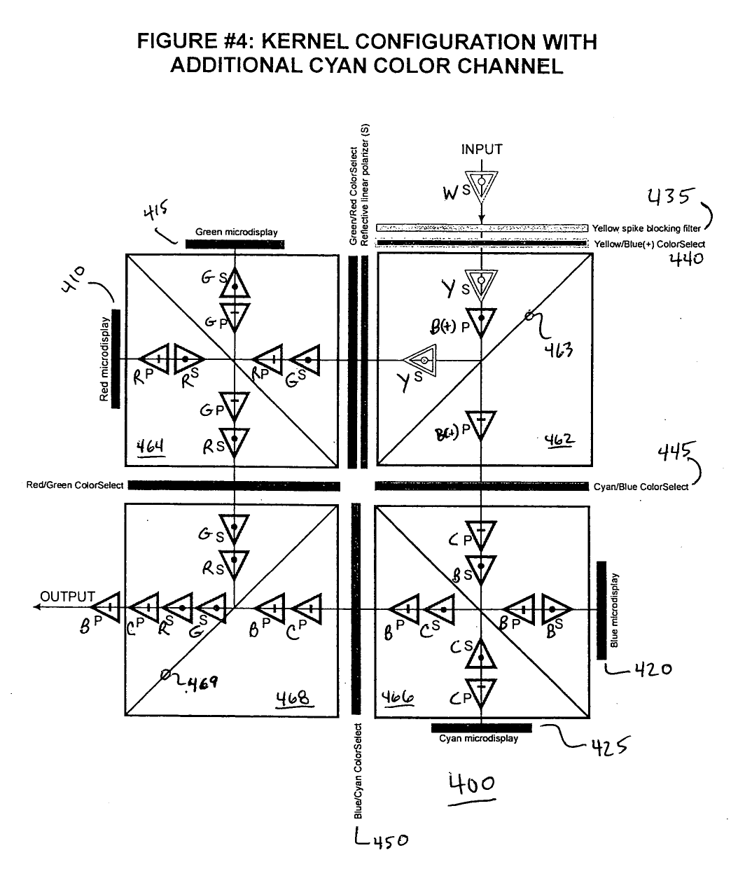

Turning now to FIG. 4, a kernel 400 according to the present invention is illustrated. Positions of the “red” 410, “green” 415 and “blue” 420 microdisplays on the kernel 400 are similar as in the conventional kernel 100 of FIG. 1. However, kernel 400 includes a cyan microdisplay 425. The cyan microdisplay 425 modulates light in a fourth color channel. The color channels are described with triangular notations including a color and polarization (W white, R red, G green, B blue, C cyan, Y yellow, M magenta (red and blue combination), S for S polarized light, and P for P polarized light).

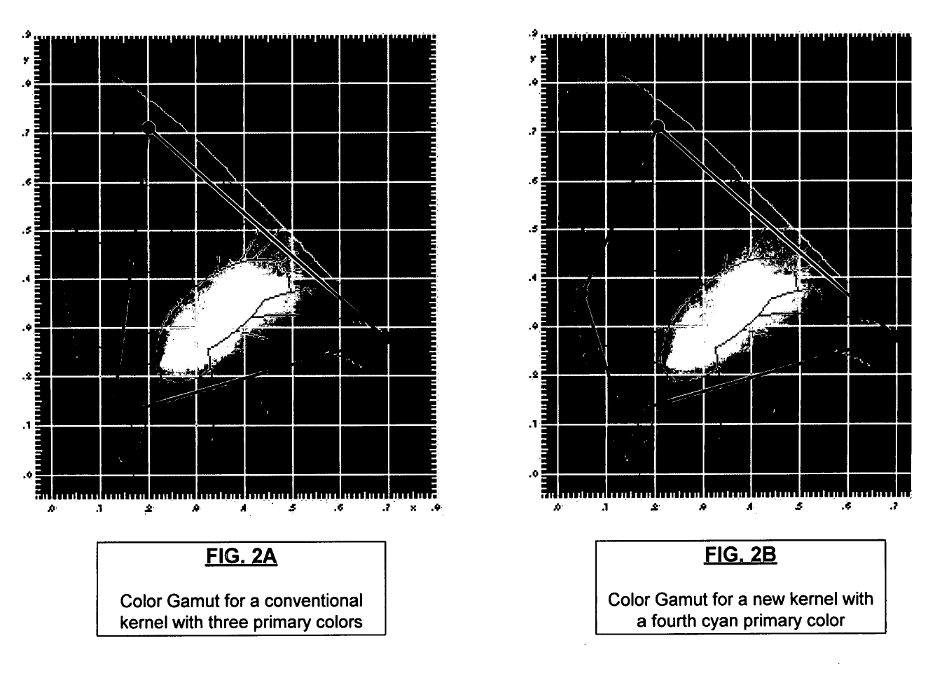

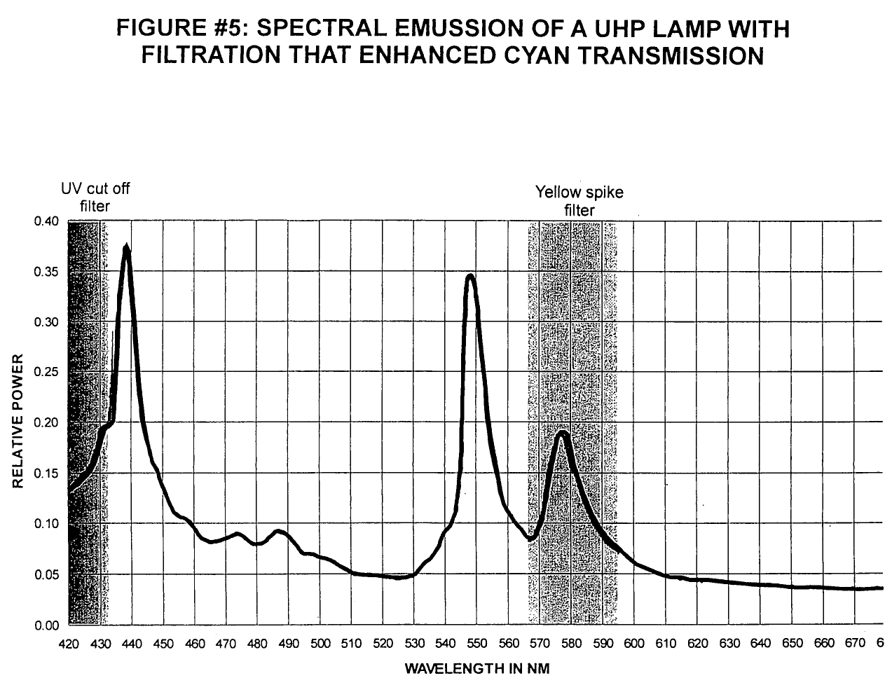

Before discussing other details related to the kernel configuration in FIG. 4, consider the rationale of this innovation. In the new configuration, cyan light previously removed from the input beam is allowed to enter the kernel 400. A new exemplar input spectrum is illustrated in FIG. 5. The cyan light is directed to the cyan microdisplay. The first consequence of the new approach is that more light is available for incorporation into the projected image. The second consequence is that the color gamut is now defined by four primary colors (red, blue, green, and cyan) (primary in the sense that all the colors in an image are produced by a combination of the four primary colors) thus enabling a color gamut that can enclose a larger space. This last point is graphically illustrated in the graph of FIG. 2B which shows a larger color gamut.

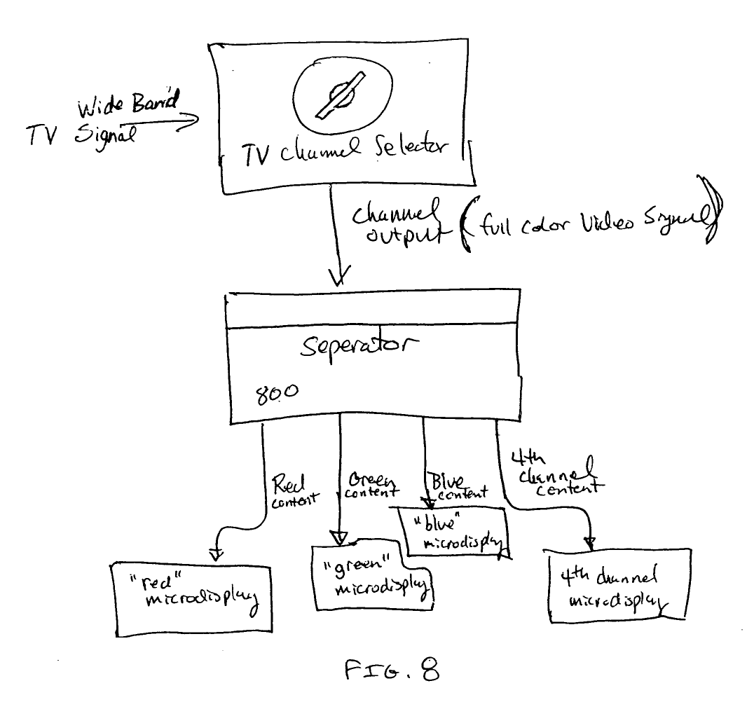

To implement this new approach, the drive electronics are modified so as to decompose the incoming full color video signal into separate signals of red, green, blue, and cyan content which are then fed to the corresponding red, green, blue, and cyan microdisplays respectively. For example, as shown in FIG. 8, a separator 800 decomposes a full color video signal into red, green, blue, and a 4th channel content. In this example, the 4^{th} channel content is related to the Cyan portion of the full color video signal.

Next, consider other details of the new kernel configuration that differ from that of the conventional kernel.
The conventional Yellow+Cyan spike blocking filter at the input has been replaced by a Yellow spike blocking filter 435. The new filter 435 still rejects the yellow spike but now transmits cyan as well as the blue. (We define Blue(+) light as blue plus cyan light.)
The conventional Yellow/Blue ColorSelect has been replaced by a Yellow/Blue(+) ColorSelect 440. The new Y/B+ColorSelect 440 does not effect the linear polarization of the red and green (together yellow) light. It rotates the linear polarization of the Blue(+) light by 90° from the S to the P polarization.

The conventional half waveplate has been replaced by a Cyan/Blue ColorSelect 445. When the Blue(+) light encounters the Cyan/Blue ColorSelect 445 the polarization of the cyan light is unaffected. The linear polarization of the blue light is rotated by 90° from the P to the S polarization.

The final new component is the addition of a Blue/Cyan ColorSelect 450. It does not effect the polarization of the blue light. It rotates the linear polarization of the cyan light by 90°.

With the described combination of optical components, the blue light is directed to the “blue” microdisplay 420 and the cyan light is directed to the “cyan” microdisplay 425. The red and green channels of the new kernel are similar to those shown in the conventional kernel. Light from all the channels is combined into full color video at beam splitting layer 469 of output kernel 468. The combined full color video is then output from the kernel to a projection lens for projection onto a screen. The screen is, for example, a screen of a high definition rear projection television. The screen may also be a screen receiving a front video projection from the kernel, for example, a widescreen display in a conference room, a display at a trade show, a projection onto a building side, etc.

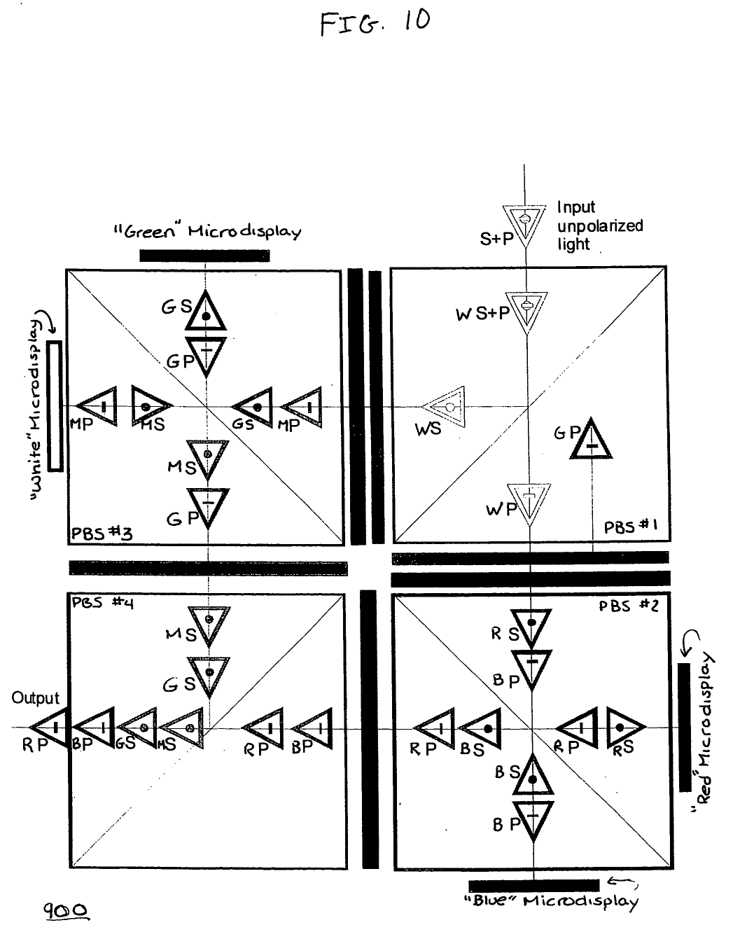

In the embodiment of FIG. 4, kernel 400 is constructed from a set of beam splitters 462, 464, 466, and 468. Light in each beam splitter is either separated or combined at a beam splitting film, or layer, disposed between the pair of prisms in each beamsplitter. In this embodiment, the beam splitting layer is, in each beamsplitter, a polarization sensitive layer that reflects light of a specified relative polarization (e.g., S polarization), and passes light of an orthogonal polarization (e.g., P polarization). For example, beam splitter 462 is 2 triangular right angle prisms abutted at their diagonals with a polarization sensitive beam splitting layer (or layers) 463 disposed between the diagonals. The incoming light is split into its yellow and blue component light beams based on the polarization of each component light beam. However, the techniques of the present invention include kernels that utilize other arrangements for splitting the incoming light into component light beams. For example, the present invention is clearly applicable to any kernel design that separates light into component light beams based on the color of the component light beams (e.g., separation using a dichroic beam splitter). Further, the present invention may be incorporated into kernel designs other than a quad style prism assembly (e.g., 3D prisms, or other kernel configurations). FIG. 10 illustrates the main optical features of an example of a 3D kernel design. Further details can be found by reference to U.S. Pat. No. ______ issued ______ which is based on U.S. Provisional Patent Application Ser. No. 60/587,616, entitled “A 3D Kernel and Prism Assembly Design,” filed Jul. 12, 2004, Attorney Docket No. 356508.03800, the contents of which are incorporated herein by reference in their entirety.

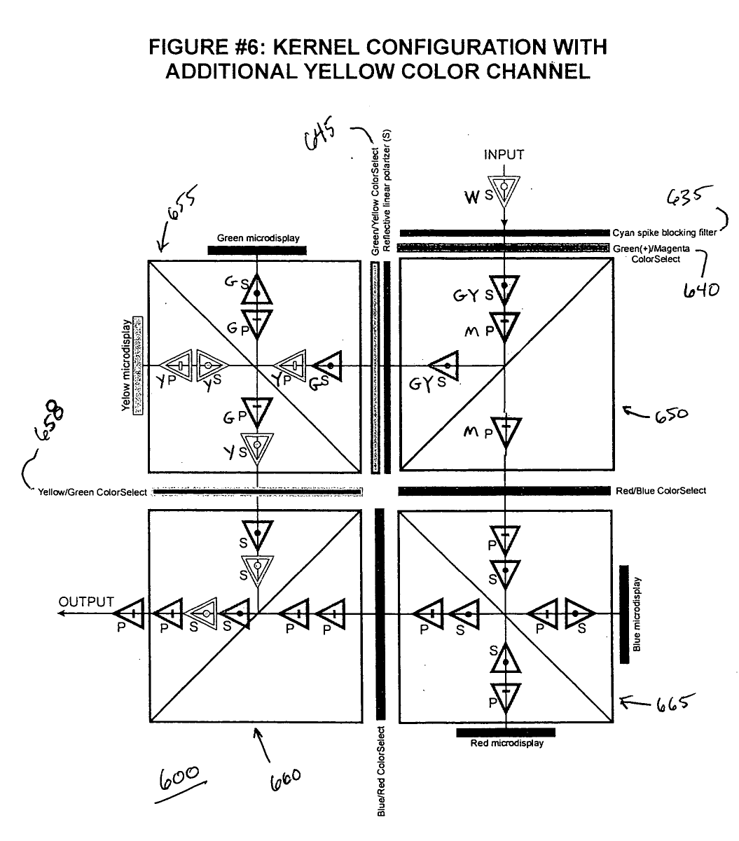

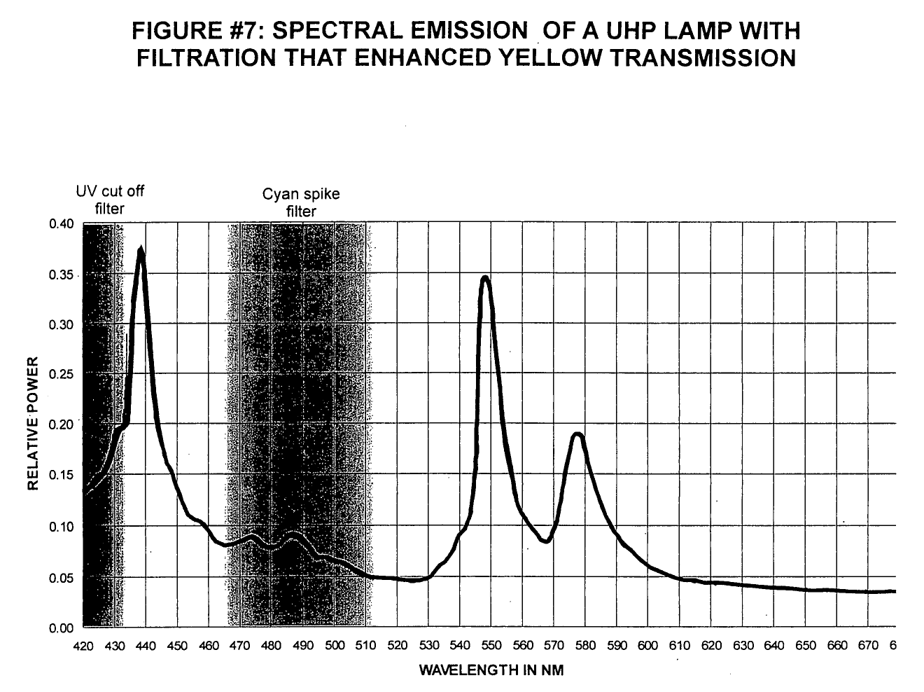

A second new kernel configuration is illustrated in FIG. 6. Although the organization of the components in this kernel differ from that presented in FIG. 4, the configuration and general principles of operation are the same. In FIG. 6, light contained in the yellow portion of the spectrum is allowed to enter the prism assembly. Another new example input spectrum is illustrated in FIG. 7. The yellow portion of the spectrum entering the prism assembly is directed towards and modulated by a yellow microdisplay. Once again, the result is an increase in the image brightness and the color gamut. The configuration of FIG. 6 includes a cyan spike blocking filter 635, a Green(+)/Magenta ColorSelect 640, a Green/Yellow ColorSelect 645, and a Yellow/Green ColorSelect 658 (We define Green(+) light as green plus yellow light).

As seen in FIG. 6, the Green(+)/Magenta ColorSelect 640 rotates the linear polarization of magenta light passing through it by 90°. The Green/Yellow ColorSelect 645 rotates the linear polarization of yellow light passing through it by 90°. And, the Yellow/Green ColorSelect 658 rotates the linear polarization of green light passing through it by 90°. The ColorSelects are commercially available optical components manufactured for a wide variety of standard and specific wavelengths.

Beam splitters (e.g., beam splitters 650, 655, 660, and 665) are preferably constructed of prism components having a beam splitting element on at least one of the diagonals of the prism components. However, other beam splitting devices may be utilized. The beam splitting element is, for example, a polarization sensitive element that reflects S polarized light and passes P polarized light.

In one embodiment, the beam splitters are pathlength matched beam splitters (defined as a path of light entering the beam splitter perpendicular to an input face, whether reflected or passed by the beam splitting element, travels the same distance within the beam splitter), and the prism assembly is a pathlength matched prism assembly (defined as a prism assembly where individual light beams within each of the color channels and corresponding to a same pixel (e.g., red, blue, green, and cyan light beams corresponding to a single pixel in an output image) travel equivalent distances within the prism assembly after being modulated).

There are many possible kernel configurations and even more possible ways that they can be modified to include an additional yellow and/or cyan color channel. The present invention includes all such modifications or other designs that utilize the principles of the invention disclosed herein.

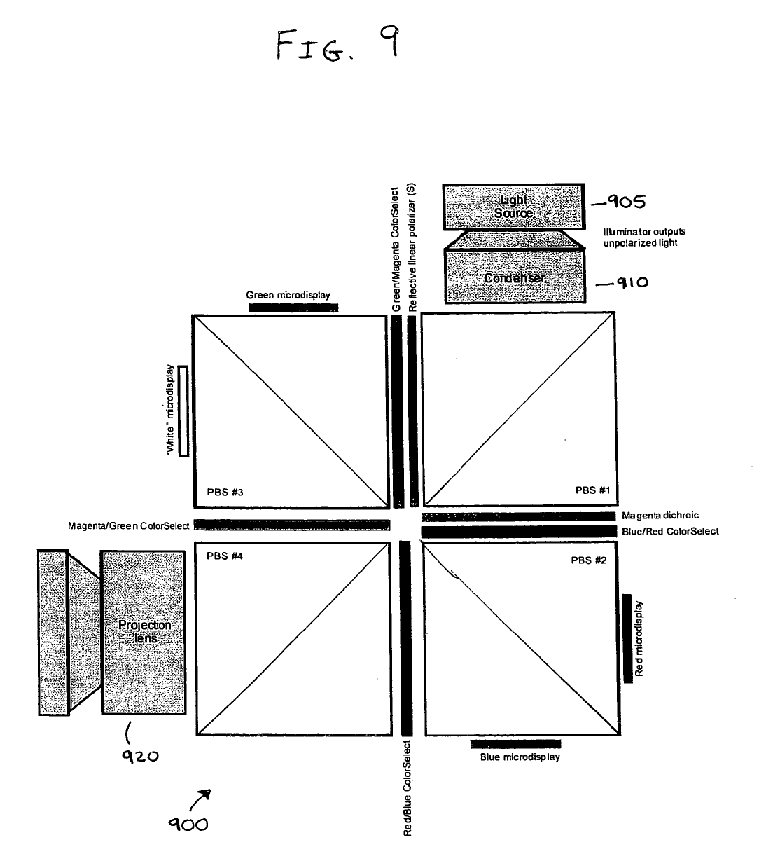

Referring now to FIG. 9, there is a kernel 900 according to an embodiment of the present invention. The kernel 900 receives unpolarized input light from an illuminator (light source 905 and condenser 910). The input light is divided into light channels, one channel directed at each microdisplay. For example, a channel of green light is directed at the “green” microdisplay, a channel of red light is directed at the “red” microdisplay, and a channel of blue light is directed at the “blue” microdisplay. The microdisplays are “red”, “green”, or “blue” which indicates that they respectively display (modulate) the red, green, or blue content of an image to be projected from the kernel. The modulated light channels are recombined and then focused by a projection lens 920 onto a viewing screen. The kernel 900 also includes a “white” microdisplay, described below, that increases the brightness (provides a “white” boost) of the image to be projected.

The way in which input light is manipulated as it travels through the disclosed kernel 900 is illustrated in FIG. 10. There are several points that can be explained regarding this optical system to enhance understanding.

The light source within a light engine of an image projector (e.g., light source 905) is typically a short arc mercury lamp such as the line of UHP lamp products sold by Philips Corporation. Lamps of this type emit roughly twice as much green light as red and blue (the intensity of red and blue light is similar). With this fact in mind, consider the intensity of the various light beams as they travel through the kernel illustrated in FIG. 10.

The intensity of the unpolarized light (white, or W S+P) entering the PBS #1 of the kernel 900 can be roughly described as 1 unit red, 1 unit blue and 2 units green. The light transmitted into PBS #2 consists of ½ unit red and ½ unit blue. These values represent the maximum amount of red and blue light that can be contributed by these channels to the projected image. Note that to produce a balanced white point, ½ unit of green must be added to this red/blue contribution.

The amount of light entering PBS #3 consists of ½ unit red, ½ unit blue and 1 unit green. The ½ units of red and blue are transmitted to the “white” microdisplay and the 1 unit of green is reflected upwards to the “green” microdisplay (Note that the “white” microdisplay has a channel of red and blue light directed at it). After modulation, the green light is recombined with the red and the blue in the lower portion of PBS #3. At this point, ⅓ unit of the green can be thought of as balancing the 1/2 units of red and blue modulated by the white microdisplay. This can be thought of as a “white boost”. The other ½ unit of green balances the red and blue contributed from PBS #2 when the beams are combined at the output of the PBS #4. This channel can be thought of as producing the conventional full color image.

Another significant feature of the disclosed kernel 900 is that the light input is unpolarized. The illuminator is, therefore, more efficient than an equivalent illuminator that outputs polarized light and that requires inclusion of a “lossy” polarization conversion system.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, the present invention is generally described with referring to quad style kernels, but it should be understood that any type of kernel configuration may be adopted to include the use of an additional color channel (e.g., “white,” yellow, cyan, or another color channel) to increase brightness in a manner similar to that described above. Therefore any other equivalent device, or other devices having an equivalent function or capability, whether or not listed herein, may be substituted therewith. The present invention may be applied to kernel styles or projector configurations that utilize either polarized or unpolarized input light, or other light modulators (e.g., reflective microdisplays and/or transmissive LCDs).

Regardless of the embodiment, the present invention includes electronics in the form of hardware or a combination of hardware and firmware and/or software configured to drive the electronics (e.g., microdisplays) of the disclosed and/or other kernel designs. The microdisplays are, for example, reflective LCOS microdisplays. The kernel 900 described above includes a light budget (allocation of light units in each of the above described light channels) that results in a balanced white point producing a bright image. To maximize use of the light budget, the electronics drivers (driver of each of the “red”, “green”, “blue”, and “white” microdisplays) determine how much light is to be reflected, on a pixel-by-pixel basis, from each microdisplay. Many different methods for processing and determining the amount of reflectivity for each pixel of each microdisplay are possible. Considerations such as the efficiency of the components of the kernel, the sensitivity of the eye to various portions of the spectrum, room lighting, and other factors may be taken into account. In one embodiment, user preferences are taken into account.

For example, an input signal including a pixel of an unsaturated blue (original “blue” pixel) would be eligible to add brightness by appropriately energizing a corresponding pixel in the “white” microdisplay (corresponding to the original “blue” pixel). At the same time, the amount of light reflected from the “green” microdisplay that also corresponds to the same original “blue” pixel would be increased to compensate (combine with) the red and blue added from the energized corresponding pixel of the “white” microdisplay. The amount of “energization” of the corresponding pixel of the “white” microdisplay and the amount of increased reflectivity of the “green” microdisplay are, for example, dependent upon the degree of unsaturation of the original “blue” pixel.

In the immediately preceding example embodiment, if the original “blue” pixel was fully saturated then the “white” microdisplay would not be energized. Similarly, if the original “blue” pixel was fully unsaturated, then the “white” microdisplay would be energized at a higher level. Amounts of unsaturation of the original “blue” pixel between fully saturated and fully unsaturated would result in the “white” microdisplay being energized at level between these two extremes.

FIG. 8 is a schematic block diagram of an example set of electronics (color separator/processor 800) used to drive microdisplays according to various embodiments of the present invention. Processing to determine reflectivity of each pixel in each microdisplay can be performed in “real” time (e.g., 60 times per second) using commercially available electronic components (e.g., electronics and/or combination of electronics and firmware/software). The electronics and/or electronics/software combination are programmed or otherwise configured according to the particulars of the kernel and microdisplays being energized. Signals output from the color separator/processor 800 include individual drive signals for each of “red”, “blue”, “green”, and “white” microdisplays of a kernel. Alternatively, the reflectivity of each microdisplay may be calculated for an image or video off line, stored in digital format, and then directly presented in sequence to drive each microdisplay. The reflectivity of each microdisplay as used herein refers to the amount of light reflected from the microdisplay that is intended to be part of a final image to be displayed.

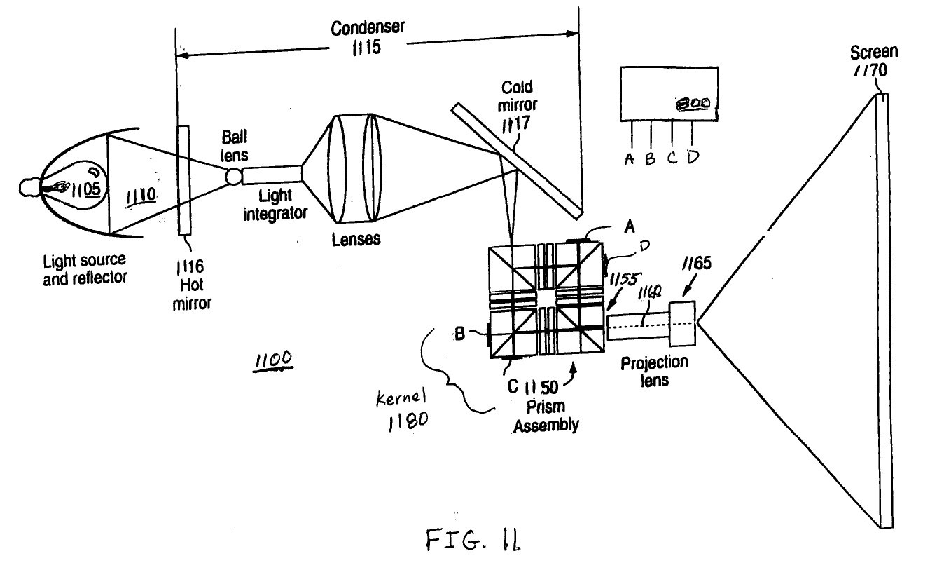

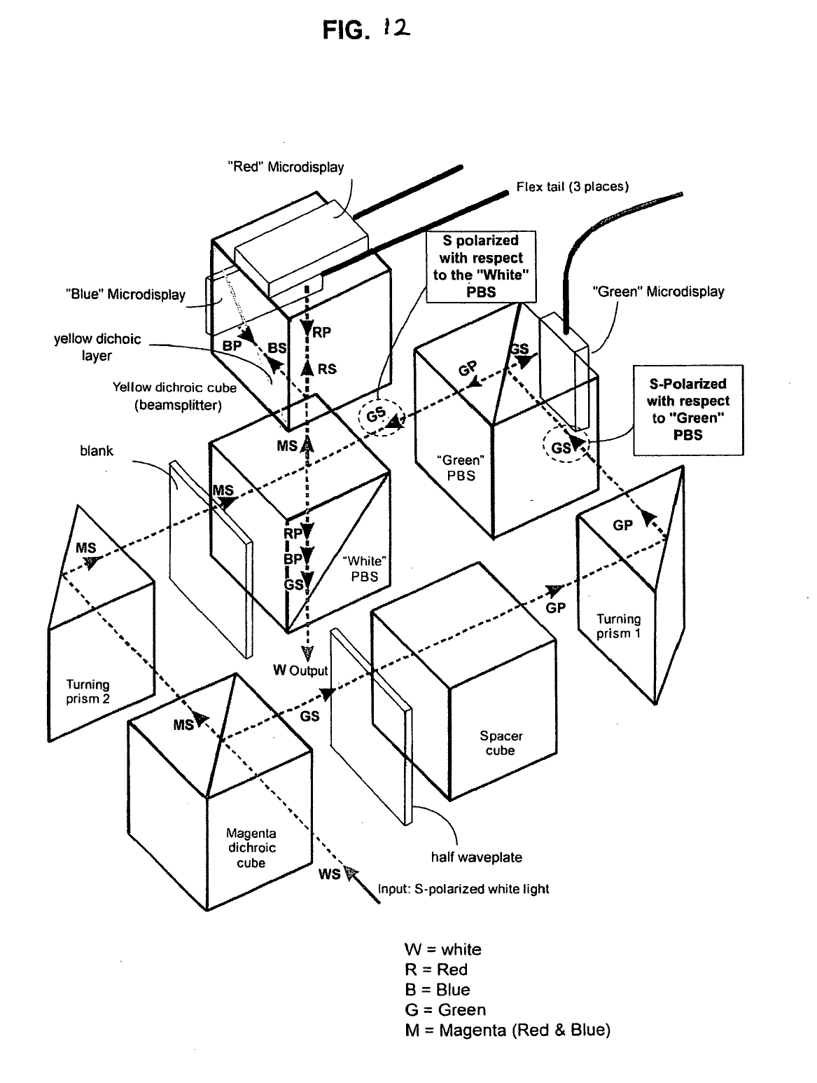

FIG. 11 is a drawing of a light engine or light management system (LMS) according to an embodiment of the present invention. Kernel 1180 modulates red, blue, green and white microdisplays according to signals produced by a color separator/processor 800. A final image projected onto screen 1170 is brightened by inclusion of a fourth, “white” light channel and a corresponding white microdisplay. In one embodiment, an amount of modulation of the fourth light channel is at least partly dependent upon a user input. For example, a remote control on a projection television incorporating a four channel kernel according to one or more embodiments of the present invention includes an adjustment feature to increase/decrease the amount of modulation in the fourth light channel. In another embodiment, the amount of modulation in the fourth light channel is determined in part based upon an overall brightness selection made by a user.

When describing ColorSelect materials, the invention is not limited to materials prepared by a single manufacture, but instead should be considered with respect to any optical device capable of producing a desired result similar to that described herein. The ColorSelect materials may be, for example, any optical device that rotates the polarization of selected wavelengths of light by the prescribed amount. And, adjustments or modifications to the designs presented herein may be made to utilize materials having different properties. Listing all the possible combinations of components to do so herein would be voluminous and not add significant pertinent disclosure.

Accordingly, all described items, including, but not limited to ColorSelect materials, filters, prisms, kernels, beamsplitters, microdisplays, etc should also be consider in light of any and all available equivalents. Furthermore, the inventors recognize that newly developed technologies not now known may also be substituted for the described parts and still not depart from the scope of the present invention.

Portions of the present invention may be conveniently implemented using a conventional general purpose or a specialized digital computer or microprocessor programmed according to the teachings of the present disclosure, as will be apparent to those skilled in the computer art after review of the present disclosure.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, micro-drive, and magneto-optical disks, ROMs, RAMS, EPROMS, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media) the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, determining color saturation levels, and calculating microdisplay reflectivity amounts (e.g., red, green, blue, and white).

The present invention may suitably comprise, consist of, or consist essentially of, any of element (the various parts or features of the invention) and their equivalents as described herein. Further, the present invention illustratively disclosed herein may be practiced in the absence of any element, whether or not specifically disclosed herein.

Obviously, numerous modifications and variations of the present invention are possible in light of the above teachings. It is therefore to be understood that within the scope of the appended claims, the invention may be practiced otherwise than as specifically described herein.

1. A kernel, comprising:
a first processing beam splitter comprising a first input face, a first processing face, and a second processing face;
a second processing beam splitter comprising a second input face, a third processing face, and a fourth processing face;
a first microdisplay coupled to the first processing face;
a second microdisplay coupled to the second processing face;
a third microdisplay coupled to the third processing face;
a fourth microdisplay coupled to the fourth processing face;
an input beam splitter configured to,
split an incoming beam of light into first and second component light beams,
direct the first component light beam to the input face of the first processing beam splitter, and
direct the second component light beam to the input face of the second processing beam splitter; and
an output beam splitter configured to recombine output lights of the first processing beam splitter modulated by the first and second microdisplays and output from the second processing beam splitter modulated by the third and fourth microdisplays.

2. The kernel according to claim 1, wherein the kernel comprises a quad style kernel.

3. The kernel according to claim 1, wherein the kernel comprises a quad style kernel and the first processing beam splitter and the second processing beam splitter are arranged in opposite corners of the quad.

4. The kernel according to claim 1, wherein the kernel comprises a prism assembly having four light channels.

5. The kernel according to claim 1, wherein the kernel comprises a four light channel kernel wherein the first microdisplay modulates content of the first light channel, the second microdisplay modulates content of the second light channel, the third microdisplay modulates content of the third light channel, and the fourth microdisplay modulates content of the fourth light channel;
the first, second, and third light channels each comprise one of red, green, and blue light channels; and
the fourth light channel comprises a fourth color light channel.

6. The kernel according to claim 1, wherein the kernel comprises for 4 light channel kernel wherein the first microdisplay modulates content of the first light channel, the second microdisplay modulates content of the second light channel, the third microdisplay modulates content of the third light channel; and the fourth microdisplay modulates content of the fourth light channel;
the first, second, and third light channels each comprise one of red, green, and blue light channels; and
the fourth light channel comprises at least one of a yellow light channel, a cyan light channel, and a white light channel.

7. The kernel according to claim 1, wherein the kernel comprises for 4 light channel kernel wherein the first microdisplay modulates content of the first light channel, the second microdisplay modulates content of the second light channel, the third microdisplay modulates content of the third light channel, and the fourth microdisplay modulates content of the fourth light channel;
the first, second, and third light channels each comprise one of red, green, and blue light channels; and
the fourth light channel comprises one of a yellow light channel, a cyan light channel, and a white light channel.

8. The kernel according to claim 1, wherein the kernel comprises a four light channel kernel wherein the first microdisplay modulates content of the first light channel, the second microdisplay modulates content of the second light channel, the third microdisplay modulates content of the third light channel, and the fourth microdisplay modulates content of the fourth light channel;
the first, second, and third light channels comprise red, green, and blue light channels; and
the fourth light channel comprises a yellow light channel.

9. The kernel according to claim 1, wherein the kernel comprises a four light channel kernel wherein the first microdisplay modulates content of the first light channel, the second microdisplay modulates content of the second light channel, the third microdisplay modulates content of the third light channel, and the fourth microdisplay modulates content of the fourth light channel;
the first, second, and third light channels comprise red, green, and blue light channels; and
the fourth light channel comprises a cyan light channel.

10. The kernel according to claim 1, wherein the kernel comprises a four light channel kernel wherein the first microdisplay modulates content of the first light channel, the second microdisplay modulates content of the second light channel, the third microdisplay modulates content of the third light channel, and the fourth microdisplay modulates content of the fourth light channel;
the first, second, and third light channels comprise red, green, and blue light channels; and
the fourth light channel comprises a white light channel.

11. The kernel according to claim 1, wherein the input beam splitter comprises a polarizing beam splitting cube.

12. The kernel according to claim 1, wherein the input beam splitter comprises a polarizing beam splitting cube that separates unpolarized input light into the first and second component light beams based on polarization.

13. The kernel according to claim 1, wherein the input beam splitter comprises a dichroic based beam splitter that separates the component light beams based on color.

14. The kernel according to claim 1, wherein at least three of the beam splitters comprise pathlength matched beam splitters.

15. The kernel according to claim 1, wherein at least one of the beam splitters comprise pathlength matched beam splitters.

16. The kernel according to claim 14, wherein the kernel comprises a pathlength matched kernel.

17. The kernel according to claim 1, wherein the input beam splitter is a dichroic color based beam splitter and the processing beam splitters comprise polarizing beam splitters.

18. The kernel according to claim 1, wherein the processing beam splitters comprise pathlength matched polarizing beam splitters.

19. The kernel according to claim 1, wherein at least one of the microdisplays comprises a reflective Liquid Crystal on Silicon (LCOS) microdisplay.

20. The kernel according to claim 1, wherein:
at least one of the microdisplays comprise a reflective Liquid Crystal on Silicon (LCOS) microdisplay; and
the kernel is part of a Light Management System (LMS) of a high definition capable projection television.

21. The kernel according to claim 1, wherein:
at least one of the microdisplays comprises a reflective Liquid Crystal on Silicon (LCOS) microdisplay; and
the kernel is part of a Light Management System (LMS) of a projection device.

22. The kernel according to claim 1, further comprising a Yellow/Blue(+) ColorSelect material disposed in a lightpath of the kernel.

23. The kernel according to claim 22, wherein the Yellow/Blue(+) ColorSelect is disposed at an input face of the input beam splitter.

24. The kernel according to claim 1, further comprising a Cyan/Blue ColorSelect material disposed in a lightpath of the kernel.

25. The kernel according to claim 1, further comprising a ColorSelect material disposed in a lightpath of the kernel and operative on one of two color bands comprising a cyan color band.

26. The kernel according to claim 1, further comprising a Cyan/Blue ColorSelect material disposed in a lightpath of the kernel, wherein the Cyan/Blue ColorSelect is disposed between the input beam splitter and one of the processing beam splitters.

27. The kernel according to claim 26, further comprising a Green/Red ColorSelect disposed between the input beam splitter and the other processing beam splitter.

28. The kernel according to claim 1, further comprising a Green/Yellow ColorSelect material disposed in a lightpath of the kernel.

29. The kernel according to claim 1, further comprising a ColorSelect material disposed in a lightpath of the kernel and operative on one of two color bands comprising a yellow color band.

30. The kernel according to claim 1, further comprising a Green/Yellow ColorSelect material disposed in a lightpath of the kernel, wherein the Green/Yellow ColorSelect material is disposed between the input beam splitter and one of the processing beam splitters.

31. The kernel according to claim 30, further comprising a Red/Blue ColorSelect material disposed between the input beam splitter and the other processing beam splitter.

32. The kernel according to claim 1, further comprising a ColorSelect material disposed in a lightpath of the kernel and operative to rotate polarization in one of two color bands comprising a yellow color band.

33. The kernel according to claim 32, further comprising a Green/Red ColorSelect disposed between the input beam splitter and one of the processing beam splitters.

34. The kernel according to claim 1, further comprising a Green/Magenta ColorSelect material disposed between the input beam splitter and one of the processing beam splitters and a Blue/Red ColorSelect disposed between the input beam splitter and the other processing beam splitter.

35. The kernel according to claim 1, further comprising a Green/Magenta ColorSelect material disposed between the input beam splitter and the first processing beam splitter and a Blue/Red ColorSelect disposed between the input beam splitter and the second processing beam splitter;
wherein one of the first microdisplay and the second microdisplay comprises a “white” microdisplay.

36. The kernel according to claim 1, further comprising:
a Green/Yellow ColorSelect material disposed between the input beam splitter and the first processing beam splitter;
a Red/Blue ColorSelect disposed between the input beam splitter and the second processing beam splitter;
a Cyan spike blocking filter disposed at an input of the input beam splitter; and
a Green(+)/Magenta ColorSelect disposed at the input of the input beam splitter;
wherein:
the kernel comprises a quad style kernel having the processing beam splitters in opposite corners of the quad;
the input beam splitter, the output beam splitter, and the processing beam splitters each comprise polarizing beam splitting cubes; and
one of the first microdisplay and the second microdisplay comprises a “yellow” microdisplay.

37. The kernel according to claim 1, further comprising:
a Green/Red ColorSelect material disposed between the input beam splitter and the first processing beam splitter;
a Cyan/Blue ColorSelect material disposed between the input beam splitter and the second processing beam splitter;
a Yellow spike blocking filter disposed at an input of the input beam splitter; and
a Yellow/Blue(+) ColorSelect disposed at the input of the input beam splitter;
wherein:
the kernel comprises a quad style kernel having the processing beam splitters in opposite corners of the quad;
the input beam splitter, the output beam splitter, and the processing beam splitters each comprise polarizing beam splitting cubes; and
one of the third microdisplay and the fourth microdisplay comprises a “cyan” microdisplay.

38. The kernel according to claim 1, further comprising:
a Green/Magenta ColorSelect material disposed between the input beam splitter and the first processing beam splitter;
a Magenta dichroic and a Blue/Red ColorSelect disposed between the input beam splitter and the second processing beam splitter;
wherein:
the kernel comprises a quad style kernel having the processing beam splitters in opposite corners of the quad;
the input beam splitter, the output beam splitter, and the processing beam splitters each comprise polarizing beam splitting cubes; and
one of the first microdisplay and the second microdisplay comprises a “white” microdisplay.

39. A kernel assembly, comprising:
a set of optical components comprising four processing faces;
wherein:
said set of optical components are configured to, separate light input to the kernel assembly into four separate light beams,
individually direct each light beam to a corresponding individual processing face, and
direct from each of the individual processing light beams emanating faces to a common output face of the kernel assembly.

40. The kernel assembly according to claim 39, wherein the separate light beams comprise red, green, blue, and cyan light beams.

41. The kernel assembly according to claim 39, wherein the separate light beams comprise red, green, blue, and yellow light beams.

42. A prism assembly, comprising:
an input beam splitter configured to split an input light beam entering the prism assembly into a first beam and a second beam;
a first processing beam splitter configured to separate the first beam into a first color component beam and a second color component beam;
a second processing beam splitter configured to separate the second beam into a third color component beam and a fourth color component beam;
an output beam splitter configured to combine the first, second, third, and fourth color component beams into an output beam.

43. The prism assembly according to claim 42, wherein a path of the input light beam does not include one of a yellow blocking filter and a cyan blocking filter.

44. The prism assembly according to claim 42, further comprising a yellow spike blocking filter placed in a path of the input light beam.

45. The prism assembly according to claim 42, further comprising:
a yyy/xxx ColorSelect optical component placed in a path of the second beam;
wherein the third color component beam comprises an xxx beam comprising one of a red, green, and blue light beams and the fourth color component beam comprises a yyy beam comprising one of cyan and yellow light beams.

46. The prism assembly according to claim 42, further comprising:
a xxx/yyy ColorSelect optical component placed in a path of the second beam;
wherein the third color component beam comprises an xxx beam comprising one of a red, green, and blue light beams and the fourth color component beam comprises a yyy beam comprising one of cyan and yellow light beams.

47. The prism assembly according to claim 42, further comprising a ColorSelect filter positioned in a path of one of the first beam and second beam;
wherein the ColorSelect filter comprises one of yellow and cyan colors.

48. The prism assembly according to claim 42, further comprising:
a microdisplay positioned with respect to one of the processing beam splitters so as to reflect one of the color component beams;
wherein the reflected color component beam comprises one of a yellow component beam and a cyan component beam.

49. The prism assembly according to claim 42, further comprising first, second, third, and fourth processing faces on the first and second processing beam splitters;
first, second, third, and fourth microdisplays each respectively located in conjunction with the first, second, third, and fourth processing faces and each configured to reflect one of the first, second, third, and fourth color component beams.

50. The prism assembly according to claim 49, wherein the prism assembly is configured such that one of the color component beams comprises one of a yellow color component beam and one of a cyan color component beam.

51. A light engine apparatus in an image projection device, comprising:
a prism assembly according to Embodiment B1; and
a light source that produces the input light beam;
wherein a path of the input light does not include one of a yellow blocking and cyan blocking filter.

52. A prism assembly comprising a four color light channel prism assembly wherein one of the light channels comprises one of a yellow light beam and a cyan light beam.

53. A prism assembly comprising a four color light channel prism assembly wherein at least one of the light channels is configured to contain only one of a yellow light beam and a cyan light beam.

54. A Liquid Crystal on Silicon (LCoS) based projection device, comprising:
an input light source;
a kernel, comprising, a quad style four color light channel prism assembly, and a set of LCOS microdisplays coupled to the prism assembly, the kernel configured to receive the input light, divide the input light into component light beams, individually direct each component light beam to one of the microdisplays for modulation, and recombine the modulated lights in an output beam;
a video processor configured to separate a video signal into component video signals;
an electronic coupling configured to individually deliver one of the component video signals to a corresponding one of the LCOS microdisplays;
a display screen; and
a projection lens configured to project the output beam onto the display screen.

55. The LCOS based projection device according to claim 54, wherein the projection device comprises an LCOS television.

56. The LCOS based projection device according to claim 54, wherein the first component video signal is a red component video signal, the second component video signal is a blue component video signal, and the third component video signal is a green component video signal, and the fourth component video signal is a fourth color.

57. The LCoS based projection device according to claim 54, wherein the first component video signal is a red component video signal, the second component video signal is a blue component video signal, and the third component video signal is a green component video signal, and the fourth component video signal is a yellow component video signal.

58. The LCoS based projection device according to claim 54, wherein the first component video signal is a red component video signal, the second component video signal is a blue component video signal, and the third component video signal is a green component video signal, and the fourth component video signal is a cyan component video signal.

59. The LCoS based projection device according to claim 54, wherein the fourth component video signal comprises an amount of white light to be added to each potion of the video based on the color content of the first, second, and third component video signals.

60. The LCOS based projection device according to claim 54, wherein the fourth component video signal comprises an amount of white light to be added to each potion of the video based on the color content and saturation of the first, second, and third component video signals.

61. The LCOS based projection device according to claim 60, wherein the fourth component video signal is a white video signal.

62. The LCoS based projection device according to claim 60, wherein the fourth component video signal is a yellow video signal.

63. The LCoS based projection device according to claim 60, wherein the fourth component video signal is a cyan video signal.

64. The LCOS based projection device according to claim 54, wherein the fourth component video signal comprises an amount of white light to be added to each potion of the video based on the color content, brightness, and saturation of the first, second, and third component video signals.

65. The LCOS based projection device according to claim 52, wherein the first component video signal is a red component video signal, the second component video signal is a blue component video signal, and the third component video signal is a green component video signal, and the fourth component video signal is a white component video signal.

66. The LCOS based projection device according to claim 54, wherein the fourth component video signal is calculated by the video processor based at least partly on a sensitivity of the eye to the other colors in the first, second, and third component video signals and an efficiency of the kernel in processing and directing lightpaths of the other colors.

67. The LCOS based projection device according to claim 54, further comprising an adjustment input configured to adjust an intensity of the fourth color channel.
